(19) United States
(12) Patent Application Publication
(10) Pub. No.: US 2008/0217082 A1
(43) Pub. Date: Sep. 11, 2008

(54) Skirt for Air Cushion Vehicle

(75) Inventor: David Boast, Wiltshire (GB)

Correspondence Address: MCGARRY BAIR PC, 32 Market Ave. SW, SUITE 500, GRAND RAPIDS, MI, 49503, US

(73) Assignee: AVON POLYMER PRODUCTS LIMITED, Melksham (GB)

(21) Appl. No.: 12/044,025

(22) Filed: Mar. 7, 2008

(30) Foreign Application Priority Data
Mar. 7, 2007 (GB) 0704424.1

(51) Int. Cl. B60V 1/16

(52) U.S. Cl. 180/127

(57) ABSTRACT

Skirts for air cushion vehicles that are formed from material that is tensively strengthened in at least one direction, and preferably two different directions, so as to resolve and reduce the axial and radial stresses in the skirt. The material may be strengthened by incorporation of reinforcing cords arranged to reduce the axial and radial stresses in the skirt both when a vehicle comprising such a skirt is static and when it is in motion.

### CROSS-REFERENCE TO RELATED APPLICATION

This application claims the benefit of GB Application No. 0704424.1 filed on Mar. 7, 2007, which is incorporated herein in its entirety.

### FIELD OF THE INVENTION

The present proposals relate to skirts for air cushion vehicles, such as hovercraft.

### BACKGROUND OF THE INVENTION

Air cushion vehicles provide an excellent method of transport over a variety of different terrain. They can be used to travel over both land and water and can move directly between land and water with no change to the set-up of the vehicle (unlike some other amphibious vehicles which may require uncoupling of wheels from the engine and engagement of a propeller). They achieve this by having the vehicle body supported on a cushion of air during travel.

The cushion of air in such vehicles is typically contained under the vehicle body by a skirt which passes around the base of the vehicle body and is open underneath so that the air trapped underneath the vehicle body by the skirt is in direct contact with the surface on which the vehicle is positioned.

Skirts for containing an air cushion may take one of a variety of different well known general forms (e.g., a bag skirt, a finger skirt, or a bag and finger skirt).

A bag skirt can be thought of as being formed from a continuous tube (e.g. doughnut shape) of skirt material that is situated underneath the vehicle body around its perimeter. The space in the centre of the continuous tube (i.e. enclosed by the inner walls of the tube at its edges, the base of the vehicle body above, and the surface on which the vehicle is standing below) forms the air cushion. The continuous tube is inflated with pressurised air to provide some support for the vehicle body. The air cushion is typically supplied with air from the pressurised air inside the continuous tube through holes in its inner wall.

A finger skirt is formed from a series of fingers of skirt material projecting down from the vehicle body to form a skirt underneath the vehicle body and around its perimeter and enclosing an air cushion underneath the vehicle body. Each finger is open to the air cushion on the inner side.

A bag and finger skirt is a combination of the bag skirt design and the finger skirt design. This type of skirt has a bag skirt immediately underneath the vehicle body and then a finger skirt attached to the base of the bag skirt.

Different skirt designs have different characteristics. For example, the bag skirt is simple to design and construct but it provides a harder ride and can result in a higher drag than a finger skirt or bag and finger skirt when the vehicle travels over rough or undulating surfaces. The finger skirt on the other hand gives a smoother ride with lower drag over rough surfaces but is typically less stable to pitch and roll of the vehicle than the bag skirt. The bag and finger skirt provides a combination of the stability of the bag skirt and the low drag of the finger skirt.

Bag and finger skirts typically comprise an “inner bag” portion underneath the craft at the interface between the bag portion and the finger portions. This inner bag portion typically has holes punched in it to allow the compressed air to pass from the bag region of the skirt to the finger region. In many cases, there is a pressure difference across this inner bag portion.

Bag and finger skirts may also include “webbing portions” underneath the skirt to provide additional support to various sections of the skirt (e.g. to support the finger portions). In many cases, these webbing portions also have holed punched in them to allow compressed air to pass through the webbing portion.

Due to the pressure of air inside the skirt, the material of the skirt is subjected to various stresses. In particular, the bag parts of either bag skirts or bag and finger skirts are subjected to “axial stress” and “hoop stress”.

As explained above, the bag part of these skirts is formed from a continuous tube of material. The bag part of these skirts has a base plane (marked 4 in FIG. 1) which is substantially horizontal and which runs approximately through the centre of the bag portion of the skirt and approximately parallel to the bottom of the vehicle body.

“Axial stress” (σ_{A}) is present in the continuous tube walls acting parallel to the base plane, i.e. around the perimeter of the vehicle. Whereas the “hoop stress” (σ_{H}) is present in the bag walls acting in a plane perpendicular to the base plane, i.e. around the bulging wall of the bag section of the skirt when it is inflated. These stresses may expose weaknesses in the skirt material and, where the stresses are at their greatest, they may cause the skirt material to tear open, so losing at least some of the internal pressure of the air cushion.

Furthermore, when the vehicle is in motion, it rides on the cushion of air contained within the skirt. However, the edges of the skirt are typically very close to the surface over which the vehicle is travelling, and in many cases are actually in contact with the surface over which the vehicle is travelling, especially when travelling over a rough surface (e.g. rough ground or choppy water). Therefore, there is some drag between the bottom edge of the skirt and the surface over which the vehicle is travelling which causes drag on the bottom of the skirt. This drag retards the bottom edge of the skirt so causing additional drag induced shear stress in the skirt. This drag induced shear introduces a diagonal strain, in addition to the axial strain. This diagonal strain has a component which acts in the axial direction (so adding to the axial stress σ_{A}) and a component which acts in the hoop direction (so adding to the hoop stress σ_{H}).

The materials used to form the skirts for air cushion vehicles must of course be airtight, and must also be reasonably tough to prevent degradation by friction of the bottom of the skirt with the surface over which the craft travels. Typically, these skirts are formed from fabric material which is coated with an elastomer (e.g. a rubber) to render it airtight and water resistant. The elastomer may also impart some resilient nature to the material. Known skirt materials are formed from a square woven fabric impregnated with rubber to render the skirt airtight and water resistant.

During the initial development of air cushion vehicles, a range of different materials were investigated for the formation of the skirt. For example, in order to try to decrease the wear to the bottom edges of the finger portions of skirts, tyre cord material was investigated. This material has discretely separate parallel reinforcing cords running through it to provide additional strength and wear resistance. This material has increased strength in a uniaxial direction due to the parallel arrangement of the reinforcing cords along this direction in the fabric. However, it was found that this material did not impart significantly higher wear resistance to the finger portions of the skirt and so its use was abandoned.

In the skirts according to the present invention, reinforcing cords are incorporated into the skirt material to provide greater tensile strength of the material in certain specific directions (e.g. parallel to the reinforcing cords).

### SUMMARY OF THE INVENTION

In one aspect, the present invention provides a skirt for an air cushion vehicle, the skirt having a bag portion, wherein the material forming the bag portion has a greater strength (preferably at least 20% stronger, preferably at least 30% stronger, more preferably at least 50% stronger, most preferably at least 70% stronger) in one preferred direction than in others (such as perpendicular to the preferred direction), the one preferred direction being oriented so as to resolve and reduce the axial and/or radial stresses in the skirt.

In one embodiment, the material forming the skirt may comprise a square woven fabric wherein one of either the weft or the warp of the square woven fabric is stronger than the other so as to provide a material having a greater strength along either the weft or warp direction respectively. In preferred embodiments, either the weft or the warp of the square woven fabric is at least 20% stronger than the other, preferably at least 30% stronger, more preferably at least 50% stronger, most preferably at least 70% stronger.

In an alternative embodiment, the material forming the skirt may comprise a base material which has no increased strength in a uniaxial direction, supplemented with at least one set of parallel reinforcing cords to provide the skirt material with increased strength in a uniaxial direction parallel to the reinforcing cords. Preferably the resultant material is at least 20% stronger in the direction parallel to the reinforcing cords than in the direction perpendicular to this, preferably at least 30% stronger, more preferably at least 50% stronger, most preferably at least 70% stronger.

The material for the skirt is preferably either coated with or impregnated with an elastomer material. This coating may comprise simple external coating of the skirt material or may comprise impregnation of the skirt material with the elastomer. In some embodiments, the elastomer is included in the skirt material so as to surround each individual fibre (e.g. weft or warp fibre) or cord in the skirt material. This means that the individual fibres or cords do not contact each other directly and so wear of the fibres or cords caused by frictional contact against each other during movement of the skirt material is reduced. Suitable elastomers include natural rubber, butadiene rubber, chlorosulfonated polyethylene, nitrile rubber, hydrogenated or carboxylated nitrile rubber, polyurethane, and latex.

The material forming the skirt may be formed from two or more layers of material that are bonded together, at least one of these layers having an increased strength in a uniaxial direction. In one embodiment, the skirt material may be formed from a square woven fabric which is impregnated or coated with elastomer, bonded to or integrally with a material having increased strength in a uniaxial direction (e.g. a material having a set of parallel reinforcing cords coated with or impregnated with an elastomer). In another embodiment, the skirt material may be formed by bonding together or integrally two materials having an increased strength in a uniaxial direction (e.g. a material having a set of parallel reinforcing cords coated with or impregnated with an elastomer), each of the two materials being coated or impregnated with an elastomer, with the directions of increased strength of each material being arranged so as to provide a resultant material having increased strength in a uniaxial direction.

In one embodiment, reinforcing cords are incorporated in the skirt material of the bag portion at the regions of the skirt that correspond to the corners of the vehicle, the reinforcing cords being arranged in the material so as to reduce the stress, preferably in particular the axial stress, in the skirt when the skirt is inflated. These reinforcing cords arranged in the skirt at the regions corresponding with the corners of the vehicle are known as “tension links”.

In another embodiment, reinforcing cords are incorporated in the skirt material of the bag portion all the way around the skirt.

In one embodiment, reinforcing cords are incorporated in the skirt material of the bag portion all the way around the skirt and additional reinforcing cords are incorporated in the skirt material of the bag portion at the regions of the skirt that correspond to the corners of the vehicle, these additional reinforcing cords being arranged in the material so as to resolve and thus reduce the axial stress, in the skirt when the skirt is inflated.

In another aspect, the present invention relates to a skirt for an air cushion vehicle the skirt comprising a bag portion in which the “inner bag” portion and/or the “webbing portion(s)” of the skirt comprise a mesh comprising two sets of parallel strips of material which has a greater strength along the length of the strips than across their width. In the known materials used for forming the inner bag and webbing portions of the skirt, holes are punched in a sheet of material. These holes form weak points in the sheet of material where stresses accumulate around the holes. However, where the inner bag and/or webbing portions of the skirt are formed according to this aspect of the present invention, the stresses in these portions of the skirt are not concentrated around holes in the sheet of material but instead are carried evenly by the mesh of strips of material.

In this embodiment, the two parallel sets of strips of material may be oriented at different angles to each other. For example, the angle between the two parallel sets of strips of material is preferably about 54° (i.e. one parallel set of strips is angled at about 54° to the second parallel set of strips). This arrangement forms a mesh of material strips having diamond-shaped holes between the strips. The preferred 54° angle refers to the smallest angle of the diamond-shaped holes. For example, strips arranged at a 54° angle to each other results in diamond-shaped holes having two 54° angles and two 126° angles. Preferably the angle between the two sets of strips of material is between about 30° and about 60° (i.e. the smallest angle of the diamond-shaped holes formed between the strips is between 30° and 60°).

Furthermore, the two parallel sets of strips of material may each comprise strips of different widths in order to provide a mesh having a greater strength in one direction than another.

In another aspect, the present invention provides an air cushion vehicle having a skirt as described herein.

The term “reinforcing cords” as used herein means fibres, wires cords, or other elongate flexible structures that are included in the skirt material in order to provide a skirt material having an increased strength in a uniaxial direction. Typically a bundle of filaments are twisted together to form a yarn and then a bundle of yarns are twisted together to form a reinforcing cord. These may be in addition to any fibres already present in the base material (which does not have increased strength in a uniaxial direction), or they may form an integral part of the base material (e.g. a weft insertion warp-knit material).

A preferred material for use in the bag section of air cushion vehicle skirts according to the present invention is tyre-cord material comprising at least one parallel set of reinforcing cords embedded in an elastomeric material.

### BRIEF DESCRIPTION OF THE DRAWINGS

FIG. 1 shows a side view of the front section of a hovercraft skirt. For a portion of this section, the reinforcing cords incorporated into the skirt material are shown.

FIG. 2 shows a close-up of a section of the bag portion of a hovercraft skirt showing two sets of reinforcing cords incorporated in the skirt material.

FIG. 3 shows a plan view of a corner section of a hovercraft skirt including tension links (a set of parallel reinforcing cords) incorporated into the material of the skirt around the corner section of the skirt.

### DETAILED DESCRIPTION

The present invention is preferably applicable to a skirt for an air cushion vehicle which is a either a bag skirt or a bag and finger skirt. In a preferred aspect, reinforcing cords are provided at least in the material forming the bag section of a bag skirt or a bag and finger skirt.

The reinforcing cords in the skirt material are preferably arranged to resolve axial stress to lower stress in fabric of the skirt of the air cushion vehicle.

In preferred embodiments, the reinforcing cords in the skirt are arranged parallel to each other.

In theory, the greatest reduction in hoop stress would be provided by reinforcing cords arranged perpendicular to the base plane of the skirt, i.e. directly around the bulge of the bag section of the skirt. However, reinforcing cords arranged in such a manner provide little or no resolution of axial stresses, either when the vehicle is stationary or when the vehicle is moving so increasing the drag induced shear stress due to drag forces on the skirt. Therefore, the present invention provides reinforcing cords which are arranged at an angle other than perpendicular to the base plane of the skirt.

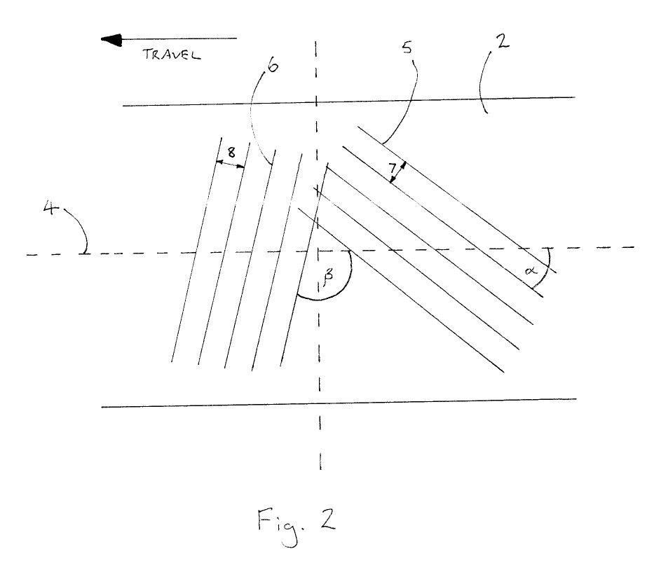

Preferably, the reinforcing cords in the skirt are arranged at an angle α to the base plane of the skirt (i.e. a plane perpendicular to the approximately circular cross section of the continuous tube when it is inflated). This angle is shown as angle α in FIG. 2.

In preferred embodiments, the skirt incorporates two sets of parallel reinforcing cords, the first set being arranged at an angle α to the base plane of the skirt, and the second set being arranged at an angle β to the base plane of the skirt.

In some embodiments, one discrete section of the skirt incorporates one set of parallel reinforcing cords being arranged at an angle α to the base plane of the skirt, and a second discrete section of the skirt incorporates a second set of parallel reinforcing cords being arranged at an angle β to the base plane of the skirt.

Preferably, the skirt comprises one set of reinforcing cords at a corner of the skirt and a further set or sets of reinforcing cords (preferably two further sets of reinforcing cords) along a section of the skirt between the corners. For example, the skirt may comprise one set of reinforcing cords arranged at an angle α to the base plane of the skirt and incorporated in a length of skirt spanning a corner of the skirt and a second set of reinforcing cords arranged at an angle β to the base plane of the skirt and incorporated in a section of the skirt between the corners of the skirt.

In embodiments where the skirt material incorporates one or more sets of reinforcing cords spanning a corner of the skirt, the reinforcing cords are preferably incorporated in a discrete region of the skirt having a length between 0.1 and 6 metres, preferably between 0.5 and 4 metre, preferably between 0.5 and 3 metres, preferably between 1 and 3 metres, preferably between 1 and 2 metres, and spanning the corner.

Preferably, the angle α is selected from between 0° and 90°, preferably between 0° and 80°, preferably between 0° and 70°, preferably between 10° and 80°, preferably between 10° and 60°, preferably between 10° and 50°, preferably between 10° and 40°, preferably between 10° and 30°, preferably between 10° and 20°. Calculations indicate that the most preferred values for a for resolution of the stresses in the skirt when the craft is in motion are between 15° and 75°, preferably between 20° and 75°.

Preferably, the angle β is selected from between 90° and 180°, preferably between 90° and 170°, preferably between 90° and 160°, preferably between 100° and 160°, preferably between 100° and 150°, preferably between 100° and 140°, preferably between 100° and 130°, preferably between 100° and 120°, preferably between 100° and 110°. Calculations indicate that the most preferred values for β for resolution of the stresses in the skirt when the craft is in motion are between 105° and 165°, preferably between 105° and 160°.

The reinforcing cords arranged at an angle α to the base plane of the skirt act to reduce the drag stress induced by motion of the vehicle. In one aspect, the reinforcing cords are arranged so that they run parallel to the direction of maximum principal stress due to the inflation of the skirt and the drag stress during motion of the vehicle.

In the skirt material, the reinforcing cords may be arranged adjacent a base skirt material (i.e. one which does not have an increased strength in any one particular dimension compared with the other dimensions) with the elastomer layer coating or impregnating both the base material and the reinforcing cords. Alternatively, the reinforcing cords are incorporated into the base layer forming a single integral layer (such as a weft insertion warp-knit material) which is subsequently coated or impregnated with an elastomer to form the skirt material.

Where the reinforcing cords are incorporated into a weft insertion warp-knit material, the reinforcing cords may be integrated in addition to and at an angle to the weft cords. For example, the angle between the reinforcing cords and the weft cords may be between about 30° and 60° so as to introduce increased strength to the material in one specific direction.

The skirt material may further include ripstop portions to prevent any rip in the material from propagating past the ripstop portion. In the materials used in the present invention, these ripstops may comprise one or more reinforcing cords that are thicker than the other cords in the material so providing increased resistance to ripping across these thicker cords. In preferred embodiments, these ripstops are incorporated at regular intervals throughout the skirt material.

The reinforcing cords in the skirt material are strong under tension but are relatively flexible. The reinforcing cords may be resilient (i.e., they stretch under tension but return to their original length when the tensile forces are released) so imparting some resilience to the skirt material.

Preferably, the reinforcing cords are made from a material selected from nylon, polyester, an aramid such as Kevlar®, and natural fibres.

In preferred embodiments, the skirt material comprises a bead around the edge of the skirt to which the ends of the reinforcing cords are anchored.

In typical applications, the present skirts can be utilised on hovercraft which are designed to travel over water. In this situation, the skirt is required to withstand both drag forces (as explained above) and also forces from waves hitting the sides of the vehicle (particularly in rough water conditions). However, as the speed of the vehicle increases, the forces from the waves hitting the sides of the vehicle become relatively less when compared to the drag forces caused by the friction between the skirt and the surface of the water. For example, at a speed of 50 knots, a typical hovercraft skirt may be expected to experience a drag force in the region of 5 tonnes (5,000 kg) per linear metre of skirt along the side of the vehicle (although this value may vary greatly depending on variables such as water conditions, size and loading of the hovercraft etc.).

Regarding the relationship between the axial stress (σ_{A}) and the hoop stress (σ_{H}) of the skirts according to the present invention, it is known that any tube with closed ends will have an axial stress that is half the value of the hoop stress (i.e., σ_{A}=2σ_{H}). Therefore, it is calculated that in order for the reinforcing cords in the skirt material to receive an approximately equal share of the axial stress and the hoop stress, two sets of reinforcing cords should be present in the material at angles α=54° and β=126° to the base plane of the skirt (at least in the substantially vertical side-portions of the skirt). These angles are the preferred angles of the reinforcing cords when the skirt material contains no additional reinforcing cords (tension links) at the corners of the skirt (i.e. when the bag section of the skirt contains only two sets of reinforcing cords). When the skirt material contains further reinforcing cords at the corners of the bag section of the skirt, e.g. to reduce the axial stress in the skirt, the angles α and β of the reinforcing cords in the rest of the skirt may be other than this preferred 54° and 126° respectively so as to account for the additional axial stress reduction provided by the corner reinforcing cords (tension links).

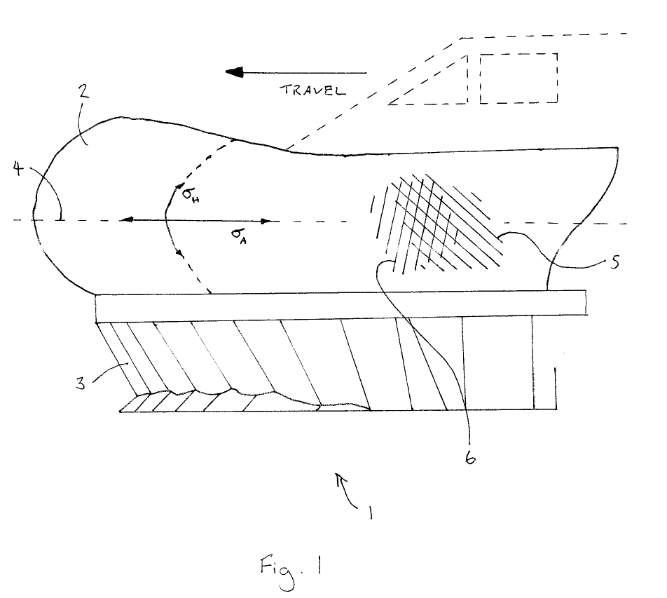

FIG. 1 shows a section of a hovercraft skirt 1. This diagram shows a bag and finger skirt with the bag section of the skirt labelled 2 and the finger section labelled 3. The cabin of the hovercraft is shown in dashed outline.

The base plane 4 of the skirt 1 is a horizontal plane through the bag section 2 of the skirt 1.

The axial stress σ_{A} of the bag section of the skirt is parallel to the base plane 4 of the skirt. Whereas the hoop stress σ_{H} is perpendicular to the base plane 4 of the skirt.

The skirt has two sets 5 and 6 of parallel reinforcing cords arranged in the skirt material. The two sets 5 and 6 of reinforcing cords are actually incorporated in the entire bag section 2 of the skirt. However, for sake of clarity, only a portion of the reinforcing cords is shown in FIG. 1.

An enlargement of a portion of the bag section 2 of the skirt showing some of the reinforcing cords incorporated therein is shown in FIG. 2. This figure shows a portion of the bag section 2 of the skirt having a base plane 4. This portion has two sets 5 and 6 of parallel reinforcing cords having a spacing 7 and 8 respectively between individual reinforcing cords. In preferred embodiments, the lateral spacing between the individual reinforcing cords is between 0.8 and 3.5 mm.

The two sets 5 and 6 of parallel reinforcing cords are arranged at angles α and β respectively to the base plane of the skirt. In preferred aspects, the value of α is less than 180°−β, i.e., the first set of reinforcing cords 5 are at a shallower angle to the base plane of the skirt than the second set of reinforcing cords 6. When the vehicle is stationary, an arrangement of reinforcing cords wherein the value of α equals 180°−β provides equal relief of stresses in the skirt in both directions longitudinally along the skirt. However, when the vehicle is in motion, the axial stress is increased due to the drag forces acting on the skirt. Therefore, the first set 5 of reinforcing cords (i.e. the reinforcing cords which are under increased tension due to the drag forces caused by the motion of the vehicle) are angled at a shallower angle to the base plane than the second set 6 of reinforcing cords. This allows the first set 5 of reinforcing cords to resolve the increased axial stress in the skirt.

The preferred angles α and β (i.e. the angle at which the reinforcing cords optimally relieve the axial stress and the hoop stress) will vary between the static condition (when the vehicle is not moving but the skirt is inflated) and the moving condition. This variation is due, at least in part, to the drag forces acting on the skirt in the moving condition which alter the angles at which the axial stress and the hoop stress act and so alter the preferred angles α and β at which the reinforcing cords are arranged. In preferred embodiments, the angles α and β are chosen to provide a balance of relief of the axial stress and the hoop stress in both static and moving conditions.

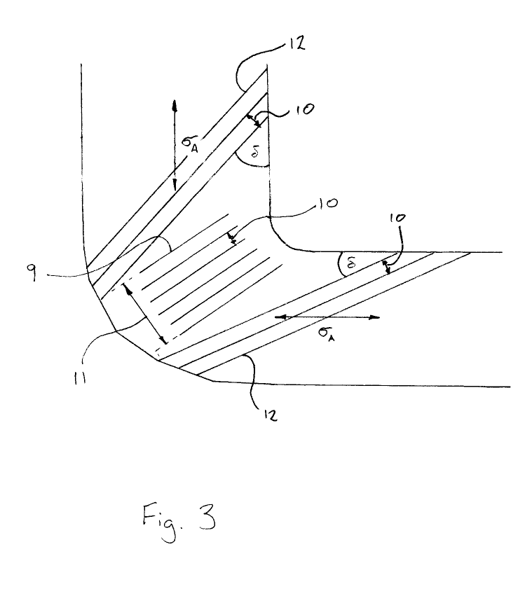

FIG. 3 shows a plan view of a corner section of a skirt according to the present invention. This figure shows two different embodiments of the present invention. The first embodiment includes a set of parallel reinforcing cords 9 (tension links). The second embodiment has two sets of parallel reinforcing cords 12 (tension links) each arranged at an angle δ to the edge of the craft. Preferably the angle δ is between 10° and 50°. In both embodiments, the reinforcing cords at the corner of the skirt are arranged to reduce the axial tension (σ_{A}) in the skirt. The tension links 9, 12 are present in addition to and independently of any sets (5 and 6) of parallel reinforcing cords that are present in the sections of skirt between the corners. The tension links 9, 12 comprise reinforcing cords laterally spaced at a distance 10 apart. The distance 10 between the individual reinforcing cords is between 0.8 and 3.5 mm. In the first embodiment, the tension links 9 are incorporated into the skirt material for a section extending a distance 11 around the corner of the skirt. In preferred aspects, the distance 11 is between about 0.1 and 6 metres, preferably about 1 and 3 metres, more preferably about 1 and 2 metres.

In respect of numerical ranges disclosed herein it will of course be understood that in the normal way the technical criterion for the upper limit is different from the technical criterion for the lower limit, i.e. the upper and lower limits are intrinsically distinct proposals.

1. A skirt for an air cushion vehicle, the skirt having a bag portion, wherein at least a portion of the material forming the bag portion is tensively strengthened in a first direction, the first direction being oriented in the bag portion so as to reduce the axial and radial stresses in the skirt when inflated.

2. A skirt according to claim 1, wherein the greater tensile strength in the first direction is provided by a first set of parallel reinforcing cords embedded in the skirt material.

3. A skirt according to claim 2, wherein the skirt is made from tyre cord material comprising the first set of reinforcing cords.

4. A skirt according to claim 3, wherein the first set of reinforcing cords are made from nylon, polyester, natural fibres or an aramid.

5. A skirt according to claim 1, wherein at least a portion of the material forming the bag portion is tensively strengthened in a second direction, the second direction being oriented differently to the first direction in the bag portion and so as to further reduce the axial and radial stresses in the skirt when inflated.

6. A skirt according to claim 5, wherein the greater tensile strength in the second direction is provided by a second set of parallel reinforcing cords embedded in the skirt material.

7. A skirt according to claim 6, wherein the skirt is made from tyre cord material comprising the first and second sets of reinforcing cords.

8. A skirt according to claim 5, wherein at least one of the first and second sets of reinforcing cords is arranged to reduce increased axial and radial stresses in the skirt when inflated due to drag on the bottom edge of the skirt during movement.

9. A skirt according to claim 5, wherein the first set of reinforcing cords is arranged at an angle α to the base plane of the skirt and the second set of reinforcing cords is arranged at an angle β to the base plane of the skirt, wherein the angle α is between 20° and 75° and the angle β is between 105° and 160°.

10. A skirt according to claim 9, wherein the angle α is about 54° and the angle β is about 126°.

11. A skirt according to claim 1, wherein the material forming the bag portion of the skirt is tensively strengthened in the first direction at least in regions corresponding to the corners of the vehicle.

12. A skirt according to claim 1, wherein the tensively strengthened portion of the bag material is at least 20% stronger under tension in the first direction than in other directions.

13. A skirt according to claim 5, wherein the tensively strengthened portion of the bag material is at least 20% stronger under tension in the first and second directions than in other directions.

14. An air cushion vehicle having a skirt according to claim 1.

15. An air cushion vehicle having a skirt according to claim 5.
